(19) United States
(12) Patent Application Publication
(10) Pub. No.: US 2025/0249533 A1
(43) Pub. Date: Aug. 7, 2025

(54) MEDIA SUPPLY DURING LASER WELDING

(71) Applicant: TRUMPF Werkzeugmaschinen SE + Co. KG, Ditzingen (DE)

(72) Inventors: Wolfgang ANDREASCH, Weinstadt (DE); Martin BLOCK, Haigerloch-Weildorf (DE); Sven KLINGSCHAT, Bietigheim-Bissingen (DE)

(21) Appl. No.: 19/188,036

(22) Filed: Apr. 24, 2025

Related U.S. Application Data
(63) Continuation of application No. PCT/EP2023/079001, filed on Oct. 18, 2023.

(30) Foreign Application Priority Data
Oct. 25, 2022 (DE) 10 2022 128 180.9

(51) Int. Cl. B23K 26/14; B23K 26/03; B23K 26/211

(52) U.S. Cl. CPC B23K 26/14; B23K 26/032; B23K 26/211

(57) ABSTRACT

A laser welding device welds two joining partners along a welding joint. The laser welding device includes: an optical monitoring device configured to be aligned with an observation region around the welding joint in order to detect a course of the welding joint; a laser welding head configured to direct a laser machining beam onto at least one of the joining partners by means of a welding optics on the basis of the detected course of the welding joint along the welding joint; and a supply device configured to provide a filler material and/or a process gas and which is arranged on the laser welding head such that the filler material and/or the process gas can be supplied to a welding process from a supply direction following the machining laser beam.

### CROSS REFERENCE TO RELATED APPLICATIONS

This application is a continuation of International Application No. PCT/EP2023/079001 (WO 2024/088852 A1), filed on Oct. 18, 2023, and claims benefit to German Patent Application No. DE 10 2022 128 180.9, filed on Oct. 25, 2022. The aforementioned applications are hereby incorporated by reference herein.

### FIELD

The present invention relates to the field of laser welding. In particular, the invention relates to the supply of filler material and/or process gas in a laser welding process, as well as to a laser welding device and a supply device for laser welding.

### BACKGROUND

Methods for laser welding, in which metallic workpieces are melted along a welding joint by means of a laser beam and welded together, are known from the prior art. In laser welding with filler material, the supply of a filler material and the supply of process gas for shielding the melt pool or the solidifying weld seam are usually carried out by separate nozzles that are mounted opposite one another on a welding head. The filler material in the form of a metal wire is preferably introduced into the interaction zone between the laser beam and the workpiece in a trailing manner, i.e., from the front in the feed direction. The process gas, preferably an inert shielding gas, such as nitrogen or argon, is directed onto the melt pool, preferably in a trailing manner, i.e., from behind, onto the solidifying weld seam or using a linear nozzle.

When filler material and process gas are supplied at the same time, access to the component is considerably restricted due to the opposing arrangement of the respective nozzles and the welding process zone is difficult or impossible to see for sensors, in particular for detecting the position of the joint (or welding joint) in the run-up with respect to the melting zone.

CN 2905302Y describes a combination nozzle for the leading supply of filler material and process gas. The disadvantage here is the rigid design of the nozzle. Regardless of the welding task, the complete nozzle is required for any media supply-even if, for example, only a supply of process gas is required to shield the melt pool, but no filler material and also no linear process gas supply to shield the solidifying weld seam. For many welding tasks, this combination nozzle therefore has an unnecessarily negative influence on the dynamics and contour freedom of the welding process.

### SUMMARY

In an embodiment, the present disclosure provides a laser welding device for welding two joining partners along a welding joint. The laser welding device includes: an optical monitoring device configured to be aligned with an observation region around the welding joint in order to detect a course of the welding joint; a laser welding head configured to direct a laser machining beam onto at least one of the joining partners by means of a welding optics on the basis of the detected course of the welding joint along the welding joint; and a supply device configured to provide a filler material and/or a process gas and which is arranged on the laser welding head such that the filler material and/or the process gas can be supplied to a welding process from a supply direction following the machining laser beam.

### BRIEF DESCRIPTION OF THE DRAWINGS

Subject matter of the present disclosure will be described in even greater detail below based on the exemplary figures. A II features described and/or illustrated herein can be used alone or combined in different combinations. The features and advantages of various embodiments will become apparent by reading the following detailed description with reference to the attached drawings, which illustrate the following:

FIG. 1 schematically shows a laser welding device according to an embodiment of the present invention;

FIG. 2 shows a block diagram explaining a method for welding two joining partners by means of a laser welding device according to an embodiment of the present invention;

FIGS. 3a-3b show a supply device according to an embodiment of the present invention according to a first variant;

FIGS. 4a-4b show a supply device according to an embodiment of the present invention according to a second variant; and

FIGS. 5a-5b show a supply device according to an embodiment of the present invention according to a third variant.

### DETAILED DESCRIPTION

Embodiments of the present invention can improve the precision of laser welding and thus the quality of welded joints, irrespective of the welding task at hand. At the same time, they can improve the dynamics and/or accessibility during laser welding with media supply depending on the welding task.

According to a first aspect, a laser welding device for welding two joining partners along a welding joint is provided. The joining partners can, in a preferred embodiment, be metallic joining partners. The laser welding device comprises an optical monitoring device that can be aligned with an observation region around the welding joint in order to detect a course of the welding joint. The phrase “around the welding joint” is to be understood in this context as meaning that the welding joint runs at least partially through the observation region and is acquired in the field of view of the monitoring device. By knowing the exact course of the welding joint, the welding process can be carried out with a particularly high degree of precision.

According to an embodiment, the laser welding device further comprises a laser welding head that is designed to direct a laser machining beam onto at least one of the joining partners by means of a welding optics on the basis of the detected course of the welding joint along the welding joint. The laser beam is, in a preferred embodiment, directed at both joining partners to be welded together. Due to the interaction with the laser beam, the joining partners are melted locally and solidify after the laser beam passes over them, forming a common weld seam. Generally speaking, a course of the welding path can be pre-programmed for a welding task to be carried out. In practice, however, the actual course of the welding joint may deviate from the pre-programmed course. If the actual course of the welding joint deviates from the pre-programmed course, the feed direction can be corrected by detecting the welding joint (using the monitoring device) in the immediate run-up with respect to the laser beam. In this way, the precision of welding and thus the quality of the welding result can be increased. In order to detect the actual course of the welding joint, the monitoring device can, in a preferred embodiment, be arranged on the laser welding head and be carried along with it. It is also possible for the monitoring device to be at least partially integrated into the laser welding head, wherein a monitoring laser beam from the monitoring device is directed coaxially to the machining laser beam onto the welding zone. The diameter of the monitoring laser beam is usually larger than the diameter of the machining laser beam. In this way, the welding joint can be detected in the run-up with respect to the laser beam even if it is coaxially aligned with the machining laser beam. The monitoring device can additionally or alternatively also comprise a camera that can be aligned at an angle or coaxially to the machining laser beam onto the welding zone. The monitoring device can, for example, be designed on the basis of an OCT system (OCT=optical coherence tomography). Suitable process monitoring technologies are marketed by the applicant, for example, under the name “SeamLine” or “OCT follow-up control and monitoring”.

In an embodiment, the laser welding device also comprises a supply device that is designed to provide a filler material and/or a process gas (or shielding gas) and which is arranged on the laser welding head such that the filler material and/or the process gas can be supplied to a welding process from a supply direction following the laser beam. In other words, the filler material and/or the process gas can be supplied to the welding process in a leading manner.

In an embodiment, the filler material is added to the welding process in an interaction zone between the laser beam and the at least one joining partner. Due to the interaction of the laser beam with the joining partners, a melt pool forms in the interaction zone, which can also be referred to as the machining region. The filler material is added to the melt pool and forms the resulting weld seam together with the joining partners during the welding process.

In an embodiment, the filler material can be supplied to the welding process by means of the supply device, preferably in the form of a wire or in powder form. A pulverulent filler material is usually supplied to the welding process under pressure together with an inert gas.

In an embodiment, the process gas can be supplied to the welding process by means of the supply device coaxially to the filler material and/or via an elongated region following the laser beam in the welding process. When supplying pulverulent filler material, a separate supply of the process gas may be necessary to shield the melt pool, as the carrier gas of the powder stream substantially replaces the effect of the process gas. The elongated region of the linear process gas supply is configured in such a way that the melt solidifying behind the melt pool, which forms the weld seam, is shielded from the environment, in particular in order to prevent oxidation caused by reactions with atmospheric oxygen.

In a preferred embodiment, the observation region of the monitoring device is offset in a surface plane of the joining partners in a first direction relative to the laser beam. Furthermore, the supply device can be arranged on a side of the laser welding head facing away from the first direction. Alternatively, a monitoring beam (for example, a monitoring laser beam) can also be arranged concentrically to the machining laser beam, wherein the observation region can be larger than a projection of the laser beam on the surface plane of the joining partners. The monitoring beam can, for example, also be moved back and forth across the workpiece (i.e., across the joining partners) in a pendulum movement transverse to the feed direction in advance of the laser machining beam. The monitoring device can acquire the welding joint in the immediate run-up with respect to the laser beam in order to specify an exact feed direction for the machining laser beam. By arranging the supply device in a manner following the machining laser beam, an unobstructed view in the feed direction of the machining laser beam can be ensured with respect to the monitoring device.

In an embodiment, the supply device and/or the monitoring device can also be rotatably arranged on the laser welding head via a common or separate rotary module. In this way, a monitoring laser beam that is not guided in a manner concentric to the machining laser beam and/or the supply device can be aligned independently of the orientation of the laser welding head, and in particular following the welding contour.

According to a second aspect, a supply device for selectively supplying a filler material and/or a process gas to a welding process is provided. The supply device is suitable for use in a laser welding device according to any one of the variants described above.

In an embodiment, the supply device comprises a mounting element that is designed to mount the supply device to the laser welding head of a laser welding device. The mounting element can comprise a rotary module that can be controlled by a machine controller or separately, using which the mounting element can be rotated about a longitudinal axis of the laser welding head. The longitudinal axis of the laser welding head can run substantially centrally through a focusing optic of the laser welding head.

In an embodiment, the supply device further comprises an elongated carrier element that is supported in the mounting element and in the interior of which a media channel is formed which extends along a carrier longitudinal axis of the carrier element. In a preferred embodiment, the carrier element can be designed to be hollow-cylindrical in shape. The carrier element can be tiltably mounted on the mounting element. For this purpose, the mounting element can in particular have a spherical or hemispherical protrusion at at least one position on its outer circumference, which can be mounted in a recess of the mounting element that is complementary in shape to the protrusion. In a preferred embodiment, a longitudinal axis of the carrier element can be arranged at an acute angle to an exit direction of the machining laser beam. For controlled tilting of the carrier element, the mounting element can, for example, have a screw (such as a worm screw) and a spring element that fix the carrier element in the mounting element from two sides. The carrier element can be pressed against the spring element by changing the rotary position of the screw. In this way, the alignment angle or the tilting position of the carrier element in the mounting element can be changed.

In an embodiment, the supply device further comprises an elongated base element that can be received in the media channel of the carrier element and in the interior of which a supply channel for the filler material is formed. The supply channel is designed to guide and supply a filler material to a melt pool during a laser welding process. In a preferred embodiment, the base element can be designed to be hollow-cylindrical in shape. In particular, the supply channel can be designed for supplying a wire-shaped filler material. Alternatively, the supply channel can also be designed for supplying a filler material in pulverulent form.

In a particular embodiment, the base element can be mounted in the media channel of the carrier element, forming an annular gap. In particular, the gap can serve as a through line for a process gas for a coaxial process gas supply.

In an embodiment, the supply device can also comprise a first gas supply element, which has the form of a hollow-cylindrical sleeve which can be slipped over the base element and mounted on the outer circumference of the base element and/or the carrier element. The mounting is, in a preferred embodiment, reversible. Depending on the welding task for which the supply device is to be used, the first supply element can be selectively attached to the supply device. For welding tasks in which no coaxial process gas supply is required to cover the melt pool, the first gas supply element can be omitted, which can have a positive effect on the weight and dimensions of the supply device and thus have a direct positive effect on the dynamics and/or accessibility of the laser welding device. For example, the base element or the carrier element can have an external thread and the first gas supply element can have an internal thread designed to engage with the corresponding external thread. Alternatively, for example, a plug-in fastener can be provided for detachably mounting the first gas supply element to the base element and/or the carrier element.

In an embodiment, the supply device can further comprise a second gas supply element. The second gas supply element can be mounted on the base element and/or the carrier element. An elongated exit opening is formed on the underside of the second gas supply element. The term “underside” refers here to a directional indication during operation of the second gas supply element, such as during a welding process. The second gas supply element further has at least two gas channels which open at an acute angle into the exit opening. The exit opening can, in a preferred embodiment, be laterally delimited by a housing. The housing can be detachably mounted on a base body of the second gas supply element. The at least two inclined gas channels and other possible connecting channels for the process gas supply can, in a particular embodiment, be milled or drilled into the base body. The base body can, in a preferred embodiment, be made of aluminum or an aluminum alloy. The lateral housing of the exit opening can, in a preferred embodiment, be made of copper or another material with good heat conduction properties. In a side view, the second gas supply element can have the approximate shape of a parallelogram or a rhombus. This form has proven to be advantageous for a leading media supply to the welding process.

In an embodiment, the second gas supply element can have a recess to receive the first gas supply element. In this case, the first gas supply element can be reversibly mounted on the second gas supply element. In this way, the second gas supply element can be mounted on the base element and/or the carrier element by means of the first gas supply element. The integration of the first gas supply element into the second gas supply element also allows for the simultaneous supply of gas to the melt pool and to the solidifying weld seam immediately following the melt pool.

In a preferred embodiment, a first gas channel can be formed for the first gas supply element, which extends from a first gas connection via the gap between the carrier element and the base element and which opens into an annular exit opening, which is formed by an annular gap between the first gas supply element and the base element. The gap between the carrier element and the base element can comprise annular sections as well as one or more channel-shaped sections. In order to form the annular exit opening, the base element has a tapered outer circumference at its exit end. The first gas supply element has a tapered inner diameter at its exit end. In the assembled state, the end of the base element protrudes beyond the end of the first gas supply element, wherein the respective conical regions at least partially overlap in the axial direction. In this manner, an annular gap is formed which directs a process gas along the outer circumference of the base element in a focused manner onto the melt pool during a welding process.

In an embodiment, the second gas supply element can have a separate, second gas connection. In other words, the gas connection of the second gas supply element is independent of the gas connection of the first gas supply element. In this manner, the coaxial and linear gas supply can be controlled independently of one another, which increases flexibility during welding and reduces process gas consumption if applicable.

In an embodiment, the base element and/or the first gas supply element and/or at least one housing of the second gas supply element surrounding the elongated outlet opening (on the underside or in the lower region of the second gas supply element) can be made of copper or a copper alloy. Alternatively, the elements in question can also be made of another material with particularly good heat conduction properties. During the welding process, the elements in question are particularly close to the interaction zone between the laser beam and the workpiece and are therefore exposed to high temperatures. Due to the good heat conduction properties of copper, the heat is dissipated into the nearest components of the supply device, which can be made of aluminum, for example, and which can, in a preferred embodiment, be actively cooled (for example by arranging cooling channels in the corresponding regions and connecting them to a cooling system). The modular design of the supply device means that the elements subject to particularly high heat load can be replaced separately, which increases the overall cost-effectiveness of the supply element.

According to a third aspect, a method for welding two joining partners along a welding joint is provided, which can be carried out by means of a laser welding device according to one of the variants described above. The method comprises detecting a course of the welding joint by means of the optical monitoring device. Here, the course of the welding joint is acquired in the run-up with respect to the machining laser beam.

In an embodiment, the method further comprises melting the joining partners by means of the machining laser beam in a predeterminable feed direction along the welding joint. The course of the welding joint detected by the monitoring device can be compared with a welding contour specified in advance by a welding program. In the event of deviations between the detected course and the specified welding contour, the feed direction of the machining laser beam can be adapted accordingly.

In an embodiment, the method comprises selectively supplying a filler material and/or a process gas to the welding process from a direction opposite to the feed direction. In other words, the filler material and/or the process gas is supplied to the welding process in a leading manner. In this regard, the media is supplied in any exclusive or combined selection of the following:
the filler material is supplied to a melt pool produced by the laser beam;
the process gas is directed (in a directed beam) onto the melt pool to shield the melt pool;
the process gas is directed onto an elongated region following the melt pool to shield the solidifying weld seam.

This selective media supply allows for the welding process to be individually and efficiently adapted to a welding task.

In a preferred embodiment, a monitoring laser beam of the optical monitoring device can be directed at least partially coaxially to the machining laser beam onto the surface of the joining partners by means of the welding optics, wherein in the surface plane of the joining partners a diameter of the monitoring laser beam is larger than a diameter of the machining laser beam. In this manner, it can be ensured that the welding joint is acquired by the monitoring laser beam in the run-up with respect to the melt pool.

Alternatively or additionally, a monitoring laser beam can be directed in the feed direction in advance of the machining laser beam onto the surface plane of the joining partners. In this manner, the monitoring laser beam can be guided completely independently of the machining laser beam and directed onto the surface of the joining partners in order to detect the welding joint.

The following description of preferred exemplary embodiments serves to explain the invention in more detail in conjunction with the drawings.

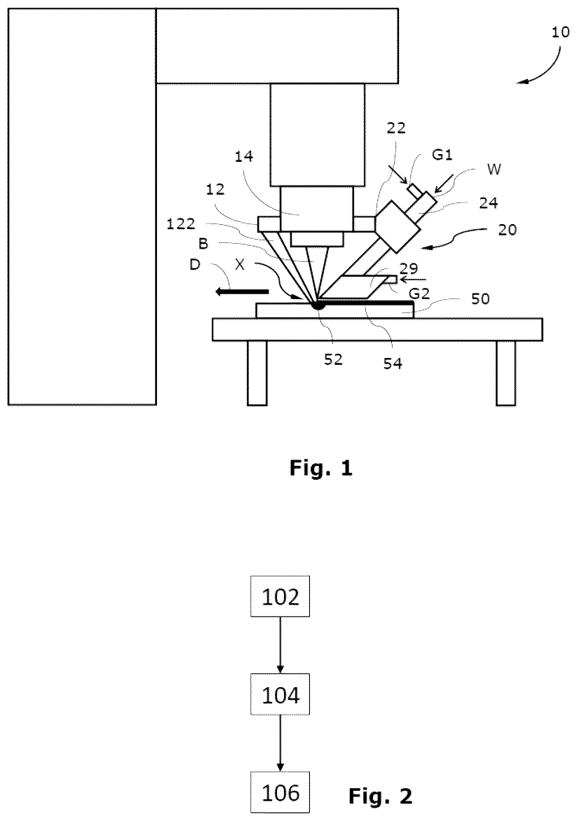

A laser welding device 10 according to an embodiment of the present invention for welding two joining partners 50 along a welding joint is described in more detail below with reference to FIG. 1. The laser welding device 10 comprises an optical monitoring device 12 that can be aligned with an observation region X around the welding joint in order to detect a course of the welding joint. In FIG. 1, the welding joint runs along the image plane. The laser welding device further comprises a laser welding head 14 that is designed to direct a laser machining beam B onto at least one of the joining partners 50 by means of a welding optics on the basis of the detected course of the welding joint along the welding joint. Since FIG. 1 shows a side view of the laser welding device 10 along a welding direction or feed direction D, one of the joining partners 50 can be seen. It should also be noted that the monitoring device 12 can be used for different types of joints. A classic area of application is the welding of two plate-shaped, metallic (such as steel, aluminum or copper) joining partners with butt joints, lap joints or T-joints. The laser welding device 10 further comprises a supply device 20 that is designed to provide a filler material and/or a process gas and which is arranged on the laser welding head 14 such that the filler material and/or the process gas can be supplied to a welding process from a supply direction following the laser beam B.

The filler material can be supplied to the welding process by means of the supply device 20 in the form of a wire or in powder form. Furthermore, the process gas can be supplied to the welding process by means of the supply device 20 coaxially to the filler material and/or via an elongated region following the laser beam B in the welding process.

According to the representation in FIG. 1, the observation region X, onto which a monitoring laser beam 122 of the monitoring device 12 is directed, is offset in a surface plane of the joining partners 50 in a first direction (which corresponds to the feed direction D in the case of FIG. 1) with respect to the laser beam B. The supply device 20, on the other hand, is arranged in a trailing manner on the laser welding head 14 with respect to the laser welding process shown, i.e., following the feed of the laser welding head 14.

In connection with FIG. 2, a method for welding two joining partners 50 by means of the laser welding device 10 is described below. In a first step 102, the method comprises detecting a course of the welding joint by means of the optical monitoring device 12. For this purpose, the monitoring laser beam 122 is directed in the feed direction D in advance of the machining laser beam B onto the surface plane of the joining partners 50.

In a second step 104, the method comprises melting the joining partners 50 by means of the machining laser beam B in the feed direction D along the welding joint. In a third step 106, the method comprises selectively supplying a filler material and/or a process gas to the welding process from a direction opposite to the feed direction D. Depending on the welding task, a filler material can be supplied to a melt pool 52 produced by the laser beam B, and/or the process gas can be directed onto the melt pool 52 to shield the melt pool 52, and/or the process gas can be directed onto an elongated region following the melt pool 52 to shield the solidifying weld seam 54.

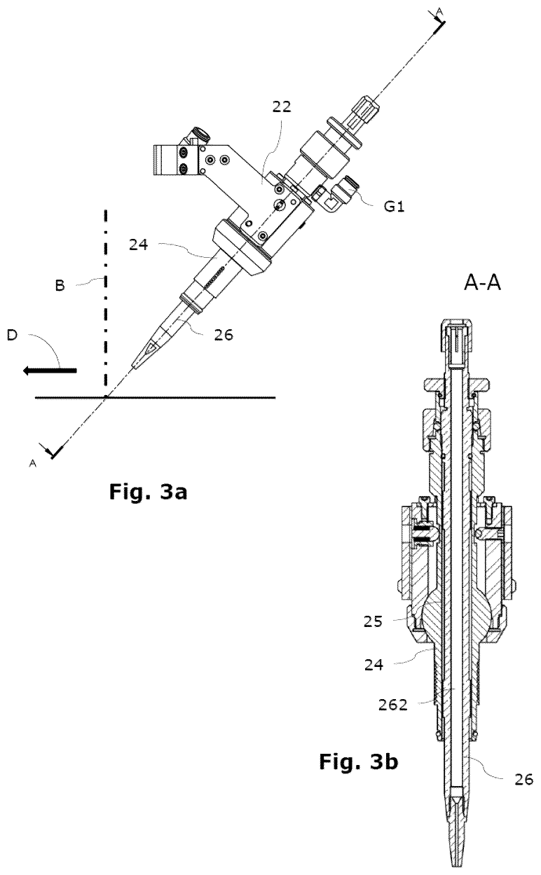

In connection with FIGS. 3a to 5b, supply devices 20 according to an embodiment of the present invention for selectively supplying a filler material and/or a process gas to a welding process according to different variants are described below. Each of the supply devices 20 comprises a mounting element 22 that is designed to mount the supply device 20 to the laser welding head 14 of a laser welding device 10. Furthermore, each supply device 20 comprises an elongated carrier element 24 that is supported in the mounting element 22 and in the interior of which a media channel is formed which extends along a carrier longitudinal axis of the carrier element 24. In addition, each supply device 20 comprises an elongated base element 26 that can be received in the media channel of the carrier element 24 and in the interior of which a supply channel 262 for the filler material is formed. A supply for the filler material into the supply channel 262 is indicated in FIG. 1 by the reference sign “W” and a corresponding arrow.

The supply device 20 according to FIGS. 3a and 3b is configured in the form shown for the sole supply of filler material, i.e., without an additional process gas supply.

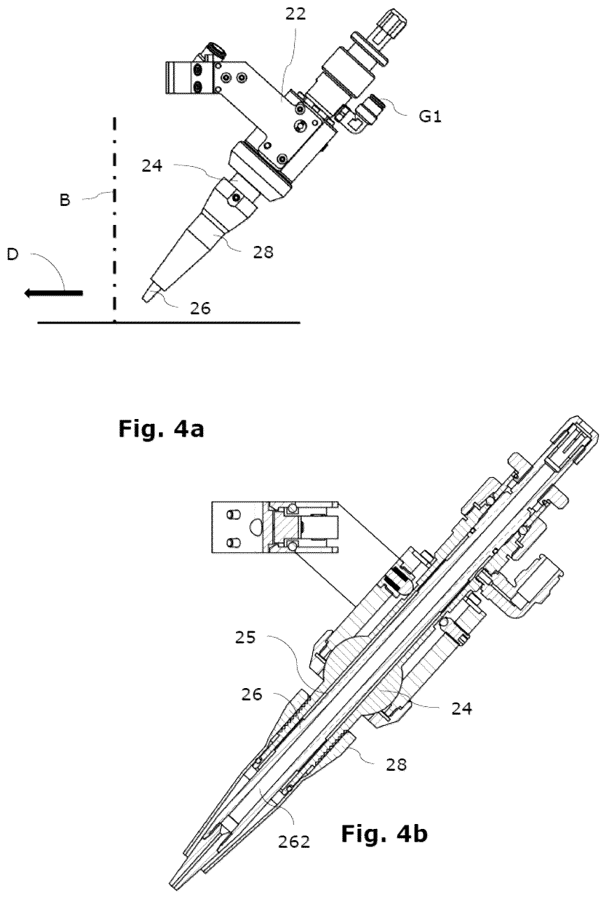

As shown in the variant according to FIGS. 4a and 4b, the supply device 20 can additionally have a first gas supply element 28, which has the form of a hollow-cylindrical sleeve which can be slipped over the base element 26 and mounted on the outer circumference of the base element 26 and/or the carrier element 24.

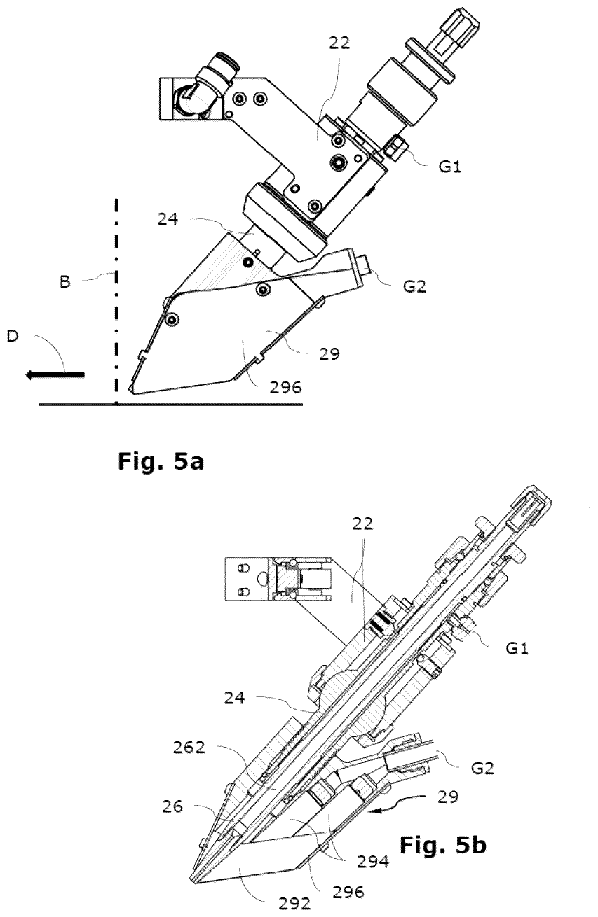

Alternatively or additionally, a supply device 20 according to an embodiment of the present invention can have a second gas supply element 29. This variant is shown in FIGS. 5a and 5b. The second gas supply element 29 can be mounted on the base element 26 and/or the carrier element 24. Furthermore, an elongated exit opening 292 for a process gas is formed on the underside of the second gas supply element 29, which can be directed via at least two gas channels 294 at an acute angle via the exit opening 292 onto a weld seam 54.

A first gas channel 25 for the first gas supply element 28 is formed between the base element 26 and the carrier element 24, which extends from a first gas connection G1 via a gap between the carrier element and the base element and which opens into an annular exit opening, which is formed by an annular gap between the first gas supply element 28 and the base element 26. The second gas supply element 29 has a separate, second gas connection G2.

The base element 26 and/or the first gas supply element 28 and/or at least one housing 296 of the second gas supply element 29 surrounding the elongated outlet opening 292 can be made of copper or a copper alloy.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A laser welding device for welding two joining partners along a welding joint, the laser welding device comprising:
an optical monitoring device configured to be aligned with an observation region around the welding joint in order to detect a course of the welding joint;
a laser welding head configured to direct a laser machining beam onto at least one of the joining partners by means of a welding optics on the basis of the detected course of the welding joint along the welding joint; and
a supply device configured to provide a filler material and/or a process gas and which is arranged on the laser welding head such that the filler material and/or the process gas can be supplied to a welding process from a supply direction following the machining laser beam.

2. The laser welding device according to claim 1,
wherein the filler material is configured to be supplied to the welding process by means of the supply device in the form of a wire or in powder form.

3. The laser welding device according to claim 1,
wherein the process gas is configured to be supplied to the welding process by means of the supply device coaxially to the filler material and/or via an elongated region following the machining laser beam in the welding process.

4. The laser welding device according to claim 1,
wherein the observation region is offset in a surface plane of the two joining partners in a first direction relative to the machining laser beam; and
wherein the supply device is arranged on a side of the laser welding head facing away from the first direction.

5. A supply device for selectively supplying a filler material and/or a process gas to a welding process and for use in the laser welding device according to claim 1; the supply device comprising:
a mounting element configured to mount the supply device to the laser welding head of the laser welding device;
an elongated carrier element that is supported in the mounting element and in an interior of which a media channel is formed which extends along a carrier longitudinal axis of the carrier element; and
an elongated base element configured to be received in the media channel of the carrier element and in the interior of which a supply channel for the filler material is formed.

6. The supply device according to claim 5, further comprising:
a first gas supply element which has a form of a hollow-cylindrical sleeve configured to be slipped over the base element and mounted on an outer circumference of the base element and/or the carrier element.

7. The supply device according to claim 5, further comprising:
a second gas supply element, configured to be mounted on the base element and/or the carrier element, on the underside of which an elongated exit opening is formed, and
which comprises at least two gas channels which open at an acute angle into the exit opening.

8. The supply device according to claim 7,
wherein the second gas supply element comprises a recess for receiving the first gas supply element and wherein the second gas supply element is configured to be mounted on the base element and/or the carrier element by means of the first gas supply element.

9. The supply device according to claim 6,
wherein a first gas channel is formed for the first gas supply element, which extends from a first gas connection via a gap between the carrier element and the base element and which opens into an annular exit opening, which is formed by an annular gap between the first gas supply element and the base element.

10. The supply device according to claim 7,
wherein the second gas supply element has a separate, second gas connection.

11. The supply device according to claim 7,
wherein the base element and/or the first gas supply element and/or at least one housing of the second gas supply element surrounding the elongated exit opening is made of copper or a copper alloy.

12. A method for welding two joining partners along a welding joint by means of a laser welding device according to claim 1, the method comprising the steps of:
detecting the course of the welding joint by means of the optical monitoring device;
melting the two joining partners by means of the machining laser beam in a predeterminable feed direction along the welding joint;
selectively supplying the filler material and/or the process gas to the welding process from a direction opposite to the feed direction;
wherein the filler material is supplied to a melt pool produced by the machining laser beam; and/or
wherein the process gas is directed onto the melt pool to shield the melt pool; and/or
wherein the process gas is directed onto an elongated region following the melt pool to shield a solidifying weld seam.

13. The method according to claim 12,
wherein a monitoring laser beam of the optical monitoring device is directed at least partially coaxially to the machining laser beam onto a surface of the two joining partners by means of the welding optics, wherein in a surface plane of the two joining partners a diameter of the monitoring laser beam is larger than a diameter of the machining laser beam.

14. The method according to claim 12,
wherein a monitoring laser beam is directed in the feed direction in advance of the machining laser beam onto a surface plane of the two joining partners.
